(19) United States
(12) Patent Application Publication
(10) Pub. No.: US 2008/0311339 A1
(43) Pub. Date: Dec. 18, 2008

(54) METHOD FOR MANUFACTURING ARTICLES IN THE FORM OF A SHEET MADE OF STONE OR STONE-LIKE MATERIAL ASSOCIATED ARTICLES

(76) Inventor: Luca Toncelli, Bassano Del Grappa (IT)

Correspondence Address: KATTEN MUCHIN ROSENMAN LLP, 575 MADISON AVENUE, NEW YORK, NY, 10022-2585, US

(21) Appl. No.: 12/175,675

(22) Filed: Jul. 18, 2008

Related U.S. Application Data
(63) Continuation of application No. PCT/EP2007/050285, filed on Jan. 12, 2007.

(30) Foreign Application Priority Data
Jan. 20, 2006 (IT) TV2006A000004

(51) Int. Cl. B32B 3/06; B29C 39/42

(52) U.S. Cl. 428/99; 264/69

(57) ABSTRACT

Method for manufacturing articles in the form of a sheet (10) using a mix comprising an agglomerated stone or stone-like material and a binder which is subjected to vacuum vibrocompression and then hardened. Plugs (20) are arranged on the forming support (22) in which the mix is deposited. One side of the plugs, which become an integral part of the article, remains flush with the side of the article (12) which does not remain visible after its installation. The article may thus be thin and easy to fit, for example in order to form a strong and lasting cladding, using fastening means (38, 40) which co-operate with the plugs (20).

Articles in the form of a sheet (10) provided with plugs (20) are also claimed.

### DESCRIPTION

The present invention relates to a method for manufacturing articles in the form of a sheet made of an agglomerated stone or stone-like material. The invention also relates to articles thus manufactured.

For many years technological processes for the manufacture of articles in the form of sheets made of an agglomerated stone or stone-like material consisting of granules with a predetermined particle size bonded either by an inorganic binder (cement-based) or by an organic binder (bonding resin) have been developed.

Particularly widespread are the technological processes known as Bretonstone™ and Bretoncemstone™ technology where a starting mix formed by granules and a binder is deposited on a temporary support, subjected to a compaction step by means of vacuum vibrocompression and then transferred for the hardening steps, the hardening steps being performed in accordance with the nature of the binder.

The sheet-like articles thus produced are panels of a very large size (approx. 3.20×1.40 metres) which at the same time may be very thin, especially when the binder is a synthetic resin (usual maximum thickness of about 3 centimetres). These articles are used for both external or internal cladding of buildings, for flooring and also for the production of furnishing elements.

A more detailed description of the abovementioned Bretonstone and Bretoncemstone technology may be obtained from the following patent texts: IT-A-1 181 570 (corresponding to U.S. Pat. No. 4,698,010), relating to the preparation of the starting mix; EP-A-0 786 325 and 1 027 205 relating to the use of organic binders, and WO-A-2004/039547 relating to inorganic binders.

At present different techniques are used for attaching said panels to the external walls of buildings.

A first possibility consists in forming a groove (“kerf”) or a series of holes or slots along each of two opposite perimetral edges (usually the two longer sides) of each panel.

The wall of the building is preferably provided with a special framework which has, fixed thereon, the hooking devices used to hang the panels one by one through the two kerfs or the series of holes or slots with which they are provided. Gaps are left between the panels adjacent in order to allow for heat expansion of the assembly and make installation easier.

This technique, however, has certain drawbacks. In fact, the presence of kerfs or holes or slots makes the edges of the panel weak and consequently reduces considerably the mechanical strength such that the thickness of the panel has to increase. An increased thickness means an increased weight acting on the supporting framework and on the structure of the building increases, with possible problems regarding the statics of the building.

Moreover, the hooking systems remain visible through the gaps between the adjacent panels, thus negatively affecting the external appearance of the cladding.

Apart from this, owing to the additional machining work required in order to obtain the kerfs or holes, the final costs for production of this cladding increases by a not small amount.

A second possibility for attaching said panels is making use of mechanical stops or locks which manage to fasten the panels by engaging with them on their outer side, but quite clearly the aesthetic appearance of the cladding is seriously compromised.

Other solutions exist as well, including the use of hooks to be attached onto the rear surface of the panels by means of expansion or deformation screws.

This solution, however, is also not without drawbacks since the small thickness, in order to limit the weight of the panels, does not ensure a strong and reliable gripping action over the years by the expansion screws.

The main object of the invention is to solve in an industrially advantageous manner the problems and drawbacks mentioned briefly above and therefore manage to obtain a thin and lightweight composite-stone panel of large dimensions which can be easily attached in a very reliable and rapid manner so as to form an outer cladding of buildings which provides suitable guarantees as regards strength and wear over time. Another object is to safeguard the aesthetic appearance of the cladding, which is also a factor of some considerable importance.

The objects are achieved by a sheet article of the above referred type, characterized in that it comprises a plug embedded in the thickness of the sheet, said plug having a thickness less than that of the sheet and a side which is substantially flush with the side opposite to that intended to remain visible after instalation of the article and being made of a material having characteristics and properties such as to allow subsequent boring and/or threading of the plug for engagement with mounting screws or bolts.

The method according to the invention in turn envisages that, within the scope of the method outlined above for manufacturing a sheet of agglomerated stone or stone-like material where a starting mix consisting of a granulated stone or stone-like material and binder is deposited, the forming support onto which said mix is deposited is provided with one or more inserts or plugs, the arrangement and the number of which are chosen depending on the final characteristics of the stone article. The aforementioned starting mix is then distributed in a thin layer, on top of the forming support, so that the inserts or plugs are incorporated in the thickness of the mix and, upon hardening thereof, become an integral part of the sheet, having one of their sides substantially flush with one of the surfaces of the sheet.

As a rule, at least four plugs are provided but the plugs can even be more if the sheet has to be divided into a certain number of panels.

As regards the arrangement of the plugs in the case of cladding, at least one plug for each corner of the panel has to be provided; it is possible to add a central reinforcing plug or provide three plugs along each side of the panel in the case this is very large and intended to clad a building situated in a zone exposed to strong winds.

A non exclusive embodiment of the invention is now described with reference to the attached drawings where:

FIG. 1 shows in a front view an article in the form of a sheet according to the invention before it is divided into four panels;

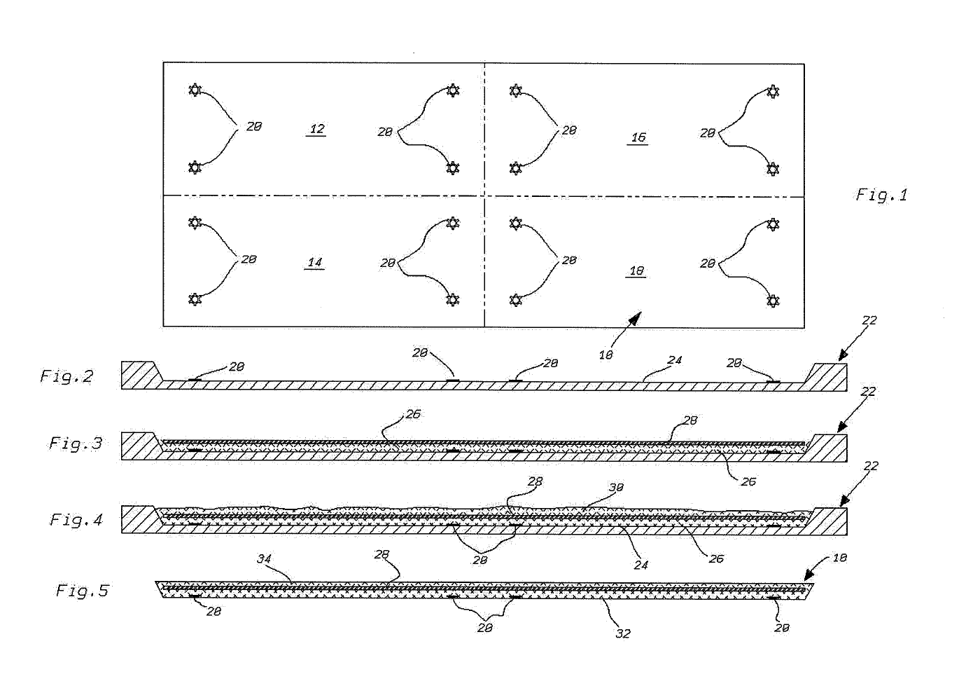

FIGS. 2, 3 and 4 show the initial steps of the method for manufacturing the article shown in FIG. 1;

FIG. 5 shows a cross-section view of the article of the FIGS. 1 to 4 at the end of the manufacturing method;

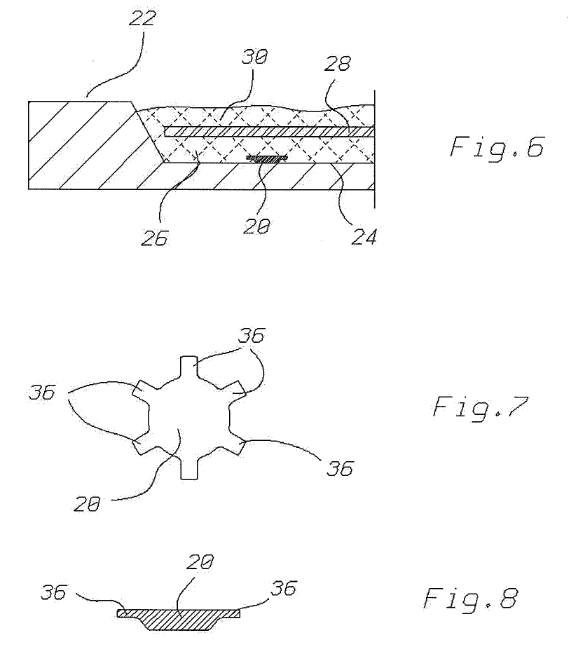

FIG. 6 shows a cross-section view of an article on a larger scale corresponding to FIG. 4;

FIG. 7 is a front view of a plug according to the invention;

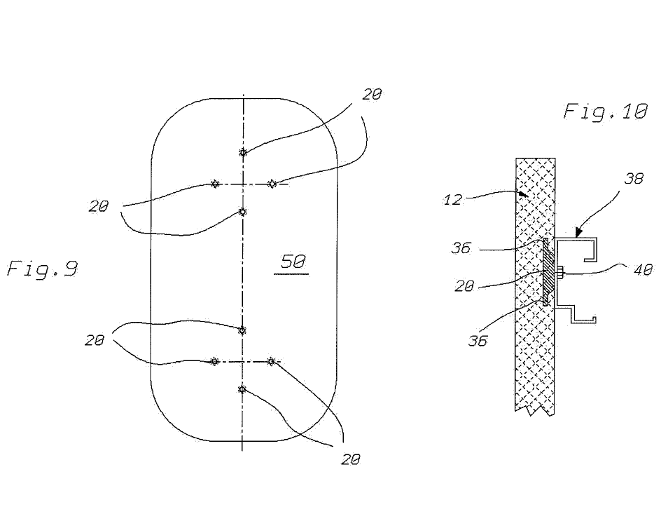

FIG. 8 is a cross-section view of the plug of FIG. 7;

FIG. 9 is a front view of a panel envisaged to be used as worktop of a table, and

FIG. 10 shows a cross-section of a panel ready for installation.

Finished sheets of a very large size (approx. 3.20×1.40 metres) are preferably made and then cut into panels. For example, the sheet 10 of FIG. 1 is envisaged to be divided into four panels 12, 14, 16 and 18 and each panel is to be provided with four plugs 20, then it is necessary to provide initially sixteen plugs, in positions corresponding to the four corners of each of the four panels to be obtained from the large sheet. The plugs 20 have a height less than the final thickness of the sheet; for example, if the final sheet 10 is 2 cm thick, the plugs 20 may have a height of about 1 cm.

FIG. 2 shows, as a forming support of the sheet 10, a rubber tray-shaped mould 22. The plugs 20 are positioned in the arrangement corresponding to FIG. 1 and temporarily attached onto the bottom 24 of the mould 22 which has been treated beforehand with a release agent.

There are various ways of attaching the plugs 20 on the bottom 24 of the mould 22.

One possibility consists in using a bonding material such as a bi-adhesive film and employing a reference template or an automated handling device for ensuring a correct positioning of the plugs.

Another possibility, although more complex, makes use of a meshwork on which the plugs 20 are fixed or glued. The meshwork is then rested on the mould 22 with the plugs 20 directed towards the bottom 24 of the mould.

Then the mix 26, which can have a composition including an expanded granulated material and/or a filler in order to obtain a particularly light sheet 10, is distributed on the mould 22 (see FIG. 3).

The sheet to be provided with plugs may also be internally strengthened (reinforced), thus assuming a collapse-proof configuration which is particularly suitable in seismic zones or even for preventing the falling of fragments from the cladding in the event of adverse phenomena affecting the building, such as accidental impacts, strong gusts of wind, etc.

For the purpose of reinforcement, fibres are distributed within the mix, approximately in the middle of the thickness. The fibres can for example be metal fibres, preferably stainless steel, having a length of a few cm and diameter of a few tenths of a millimetre.

In this case, the method of the invention envisages to distribute a first layer 26 of mix on the mould 22 so as to cover at least partly the plugs 20 and subsequently to distribute in a uniform manner (in a quantity of about 300 grammes/m²) the fibres. At last a second layer of mix is poured in a quantity such as to cover securely the fibres.

The free metal fibres do not hinder contraction of the sheet during catalysis, if the binder is a resin.

In effect, the solution according to FIGS. 3 and 4 refers to the case where a reinforcing structure, designated by the reference numeral 28, is also embedded in the mix of which the sheet 10 is formed.

In this case, after positioning the reinforcing structure 28, the second layer of mix 30 is deposited and covered with a separating sheet (not shown) before being vibrocompressed in a vacuum environment so as to obtain a compacted sheet.

The sheet is finally hardened in accordance with the nature of the binder of the mix: if the binder is inorganic (cement-based), the sheet must be left to rest for the required number of days, whereas if the binder is organic (synthetic resin), hardening is preferably performed by a heat treatment in an oven, usually with the aid of a catalyst incorporated in the starting mix.

The inserts or plugs 20 therefore remain firmly anchored inside the hardened sheet 10 and emerge on the surface 32 of the sheet opposite to the surface 34 intended to form the visible surface (FIG. 5) of the cladding.

In the case of agglomerated products made according to a method comprising the deposition of the starting mix (comprising exclusively a cement binder) on an impermeable film (not shown), the plugs 20 are attached to the impermeable film on which the cementitious mix is deposited before vibrocompression, instead of being attached onto the forming support.

The materials of which the plugs or inserts 20 are made may be of a widely varying nature.

Preferably, corrosion-resistant materials are used. In case of metal plugs the material can be stainless steel or brass or a light corrosion-resistant alloy.

Alternatively the plugs can be made of polymer materials which, as is well-known, do not pose corrosion-related problems. It is necessary, however, that the polimer materials used should be able to withstand the process temperatures to which the sheet is exposed during the manufacturing process, the said temperatures being of at least 140°. Moreover the polymer materials should have a thermal expansion coefficient similar to that of the composite stone material.

As regards the shape of the plugs 20, it may also vary greatly.

FIGS. 7 and 8 show a preferred construction of plug or insert 20 which has a frustoconical shape with a widened larger base. The smaller base of the plug 20 is intended to rest on the bottom of the forming support 22. In this way, as a result of the cross-section which widens out from the surface of the sheet 10, the pull-out strength is maximum ensuring therefore perfect anchoring of the plug. The pull-out strength is furthermore enhanced by the provision of a plurality of radial extensions 36 in the plug 20, the extensions 36 being able to remain subsequently firmly anchored inside the sheet 10.

Once it has hardened, the sheet 10 is sized, smoothed and polished on its visible surface, trimmed and if necessary cut to size. As mentioned above, a large-size sheet 10 may be used as a whole or may be divided into a plurality of panels 12, 14, 16, 18.

Each plug 20 is then bored and threaded. The bore in the plugs 20 must be situated in a position which is well-defined with respect to the peripheral shape of the sheet 10 or of the panels 12, 14, 16, 18 so that during the boring operation a second template may be used in order to define precisely the points where the bores are made.

The holes must not necessarily coincide with the centres of the plugs; in fact, boring of the plugs is preferably performed after the operation of cutting-to-size the panel since, owing to the preceding steps (deposition of the plugs on the forming support, vibrocompression, hardening and in particular trimming and cutting to size), the position of the plugs in the panel might not be exactly that desired, namely the plugs could have their axis offset a few millimetres from their intended position.

Owing to the notable pull-out strength of the inserts, fixing of the panels remains unaltered over time so that they may be very thin and therefore light, without producing an excessive weight of the building which is to be clad with the panels and the supporting framework.

The panel installation is made even easier by attaching to each plugs 20 an U-shaped hook 38 by means of a screw or bolt 40 (FIG. 10). The panels are therefore engaged in a very easy, quick and reliable manner with the profile sections (not shown) which form the supporting framework, which is in turn secured in a known manner to the wall to be clad (also not shown).

Obviously, the plugs or inserts 20 may also made so as to incorporate a nut or a bolt inserted into an axial hole, with the purpose of make their attachment as safe as the conventional expansion screws.

As mentioned above, the present invention is used mainly in case of sheets or panels for the external cladding of buildings.

However, a sheet provided with plugs which can be bored and threaded may be used for many applications: it can be used to form the internal cladding of a building or even to be a component of furnishing elements, e.g. a worktop of a table to be attached by means of the plugs to the table legs, or a kitchen top to be attached to the base units and so on.

In this case the arrangement of the plugs in the sheet could be completely different. For example, two sets of plugs 20 may be envisaged for the worktop of a table, being arranged in circles, each circle being positioned in the proximity of one end of the sheet 50 (see FIG. 9). The legs of the table (not shown) are then attached by means of the plugs.

The above description has been provided in relation to a preferred embodiment which nevertheless, within the scope of the appended claims, may be subject to many variants as regards:

(i) the nature and/or shape of the plugs or inserts;

(ii) the methods of temporarily attaching or positioning the plugs or inserts on the bottom of the forming support; and

(iii) the number and/or arrangement of the plugs.

It is also understood that, within the scope of the appended claims, the article in the form of a sheet may be manufactured using technology other than the above mentioned Bretonstone™ and Bretoncemstone™ technologies.

1. Method for manufacturing articles in the form of a sheet (10) by means of: preparing a starting mix comprising a granulated stone or stone-like material with a suitable particle size and a hardening binder; depositing a layer (26) of predefined thickness of this mix onto a forming support (22); subjecting the layer of mix contained in the support to vacuum vibrocompression; hardening the resultant sheet in conditions depending on the nature of the binder, characterized in that, before depositing the mix, said support (22) is provided with one or more plugs or inserts (20) so that they remain incorporated within the thickness of the mix, said plugs (20), having a height less than the final thickness of the sheet (10) and a frustoconical shape with the larger base widened and the smaller base positioned flush with or close to the side of the sheet (10) opposite to the side intended to remain visible after the installation of the article, whereby at the end of the hardening step, said plugs become an integral part of the sheet (10) , said plugs (20) after the hardening but before the installation of the sheet article being bored and, if necessary, also threaded so as to allow the insertion of fastening means for the installation of the articles.

2. Method for manufacturing articles in the form of a sheet (10) according to claim 1, characterized in that said plugs (20)are positioned preferably by means of a reference template or an automated handling device and temporarily attached in the forming support (22).

3. Method for manufacturing articles in the form of a sheet (10) according to claim 1, characterized in that it comprises a final step in which the sheet (10) is divided into a plurality of panels (12, 14, 16, 18), said plugs (20) being positioned in the proximity of the corners of said panels.

4. Method for manufacturing articles in the form of a sheet (10) according to claim 3, characterized in that at least one additional plug (20) is positioned in the centre of said panels (12, 14, 16, 18).

5. Method for manufacturing articles in the form of a sheet (10) according to claim 3, characterized in that at least one additional plug (20) is positioned in the centre of each of the longer sides of the sheet when the panels (12, 14, 16, 18) are of a rectangular shape.

6. Method for manufacturing articles in the form of a sheet (10) according to claim 2 when the said forming support (22) consists of a rubber tray-shaped mould, characterized in that said plugs (20) are positioned and temporarily attached to the bottom (24)—previously treated with a release agent—of the mould.

7. Method for manufacturing articles in the form of a sheet (10) according to claim 6, characterized in that said plugs (20) are temporary attached by means of a bi-adhesive film.

8. Method for manufacturing articles in the form of a sheet (10) according to claim 6, characterized in that said plugs (20) are temporary attached by means of a meshwork on which the plugs are previously fixed or glued, the said meshwork being then rested on the mould (22) with the plugs (20) directed towards the bottom (24) of the said mould.

9. Method for manufacturing articles in the form of a sheet (10) according to claim 1, characterized in that said starting mix is deposited on said forming support (22) in two successive layers (26, 30) and a reinforcing element (28) is positioned on top of said plugs (20) and arranged between said layers.

10. Method for manufacturing articles in the form of a sheet (10) according to claim 9, characterized in that said reinforcing element (28) consists of a layer of fibres.

11. Method for manufacturing articles in the form of a sheet (10) according to claim 10, characterized in that said fibres are of stainless steel.

12. Article in the form of a sheet (10) made with an agglomerated stone or stone-like material bonded with a binder, characterized in that it comprises at least one plug or insert (20) embedded in the thickness of the sheet (10), said at least one plug (20) having a height less than the final thickness of the sheet and being of frustoconical shape with the larger base widened and the smaller base positioned flush with or close to the side of the sheet (10) opposite to the side intended to remain visible after the installation of the article the plug (20) having a boring and/or threading for engagement with fastening means necessary for the installation, said boring or threading being effected after the hardening of said initial mix comprising a granulated stone or stone-like material with a suitable particle size and a hardening binder.

13. Article in the form of a sheet according to claim 12, characterized in that said at least one plug (20) has a plurality of radial extensions (36) projecting from the lateral surface of the plug.

14. Article in the form of a sheet according to claim 12, characterized in that said at least one plug (20) is made of corrosion-resistant materials.

15. Article in the form of a sheet according to claim 14, characterized in that said at least one plug (20) is made of a metal chosen from among stainless steel, brass and a corrosion-resistant light alloy.

16. Article in the form of a sheet according to claim 14, characterized in that said at least one plug (20) is made of polymer material.
